(19) United States
(12) Patent Application Publication
(10) Pub. No.: US 2004/0257481 A1
(43) Pub. Date: Dec. 23, 2004

(54) Projection television

(75) Inventor: Sang-hak Kim, Suwon city (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-SI (KR)

(21) Appl. No.: 10/820,749

(22) Filed: Apr. 9, 2004

(30) Foreign Application Priority Data
Jun. 19, 2003 (KR) 2003-039678

(51) Int. Cl. H04N 5/64

(52) U.S. Cl. 348/789

(57) ABSTRACT

A projection television comprising: a screen displaying a picture; a body casing combining with the screen, a supporting unit provided inside the body casing and supporting the bottom of the screen, and a drain hole formed on the bottom of the supporting unit and discharging moisture permeated into the screen. The projection television discharges the moisture permeated along the screen, thereby preventing the deterioration of the screen.

### CROSS-REFERENCE TO RELATED APPLICATIONS

This application claims the benefit of Korean Patent Application No. 2003-039678 filed on Jun. 19, 2003, in the Korean Intellectual Property Office, the disclosure of which is incorporated herein by reference.

### BACKGROUND OF THE INVENTION

1. Field of the Invention

The present invention relates to a projection television, and more particularly, a projection television capable of preventing a screen from deteriorating due to permeation of moisture in the screen.

2. Description of the Related Art

A conventional projection television comprises a CRT (cathode-ray tube) assembly emitting an image beam, a reflecting mirror reflecting the emitted image beam, and a screen displaying a picture with the reflected image beam.

The projection television generally comprises a full size screen.

As illustrated in FIG. 5 and FIG. 6, a conventional projection television comprises a front casing 102 forming an outer appearance together with a rear casing 107, a supporting casing 120 which is made of wood and combined between the front casing 102 and the rear casing 107, a CRT assembly 130 combined with the supporting casing 120 and emitting an image beam, a reflecting mirror 140 reflecting the image beam, a screen 110 displaying a picture with the image beam reflected by the reflecting mirror 140, a plurality of speakers (not shown) installed on the bottom of the front casing 102 and combined with the screen 110, and a circuit board 160 provided on the bottom of the supporting casing 120 to control the CRT assembly 130.

The conventional projection television displays a picture by reflecting the image beam emitted by the CRT assembly 130 toward the screen 110 with the reflecting mirror 140.

The screen 110 of the conventional projection television comprises a lenticular lens sheet 111 in the front thereof and a fresnel lens sheet 112 in the rear thereof.

The lenticular lens sheet 111 is inscribed with vertical stripe patterns on the front and back thereof, and the fresnel lens sheet 112 is inscribed with radial circle patterns, wherein the inscription of the patterns should be fine enough to make a distance between the patterns on each sheet approximately 0.1 mm.

When a user removes dirt from the screen 110 by spraying cleansing liquid along an arrow A in FIG. 6, the cleansing liquid may flow downward along the surface of the screen 110 unless the cleansing liquid is wiped off the screen immediately. As a result, the cleansing liquid permeates into a gap between the front casing 102 and the lenticular lens sheet 111 of the screen 110 and gets accumulated inside a masking tape 170. The accumulated cleansing liquid permeates between the lenticular lens sheet 111 and the fresnel lens sheet 112 according to the capillary phenomenon.

As a result, the cleansing liquid permeated between the lenticular lens sheet 111 and the fresnel lens sheet 112 is recognized as flecks by a viewer, thereby deteriorating the screen 110.

### SUMMARY OF THE INVENTION

Accordingly, it is an aspect of the present invention to provide a projection television capable of preventing a screen from deteriorating due to permeation of moisture into the screen.

Additional aspects and advantages of the invention will be set forth in part in the description which follows and, in part, will be obvious from the description, or may be learned by practice of the invention.

The foregoing and/or other aspects of the present invention are achieved by providing a projection television comprising a screen displaying a picture, a body casing forming an outer appearance of the projection television and combining with the screen, a supporting unit provided on an inside of the body casing and supporting a bottom of the screen, and a drain hole formed at a bottom of the supporting unit and discharging moisture permeated into the screen.

The supporting unit comprises an insertion groove wherein the bottom of the screen is inserted.

The supporting unit further comprises a depression formed in the center of the supporting unit and communicating with the insertion groove formed on an upper part of the depression, wherein the drain hole is formed at a bottom of the depression.

The screen comprises a lenticular lens sheet; and a fresnel lens sheet, which are combined together.

The body casing comprises a front casing comprising an upper cover having a front opening through which the screen is exposed and supports the screen, and a lower cover provided on a bottom of the upper cover; and a rear casing combining with the rear of the front casing, wherein a supporting rib protrudes inward on an inside of the upper cover along an edge of the front opening and the supporting unit is provided between the bottom of the screen and the supporting rib.

The projection television further comprises a screen supporting bracket combined to the supporting rib to support a rear of the screen.

### BRIEF DESCRIPTION OF THE DRAWINGS

These and/or other aspects and advantages of the invention will become apparent and more readily appreciated from the following description of the embodiments taken in conjunction with the accompanying drawings in which:

FIG. 1 is a perspective view of a projection television according to an embodiment of the present invention;

FIG. 2 is an exploded perspective view of the rear of a screen assembly part;

FIG. 3 is a combined perspective view of the rear of an upper cover and the screen assembly part of FIG. 2;

FIG. 4 is an enlarged sectional view showing a main part of the upper cover and the screen assembly part;

FIG. 5 is an exploded perspective view of a conventional projection television;

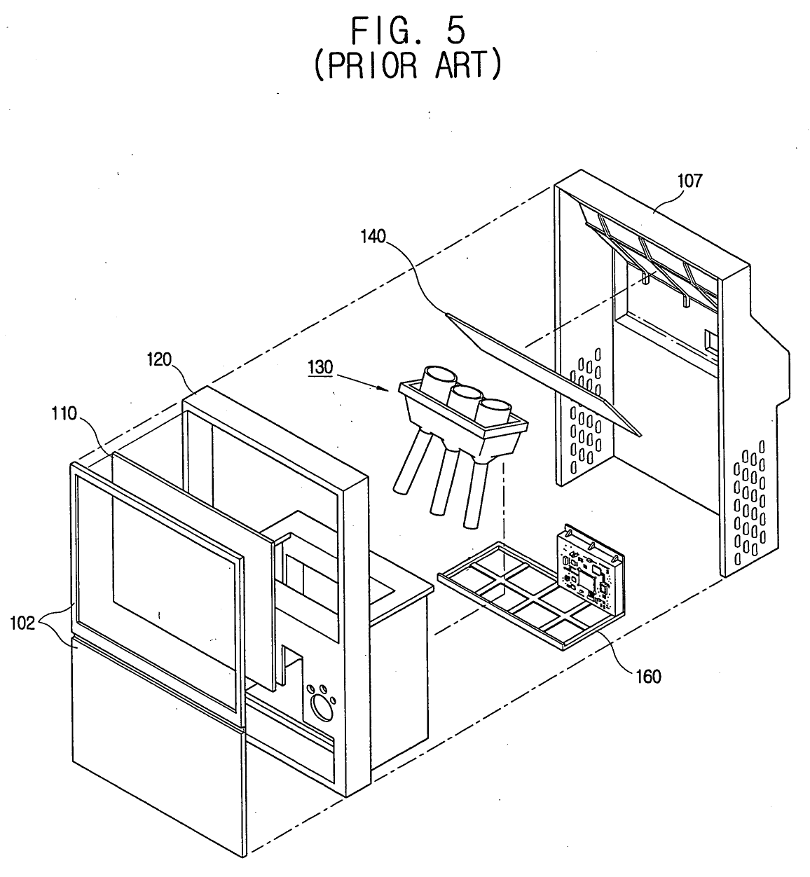

FIG. 6 is an enlarged sectional view of a screen assembly part of FIG. 5.

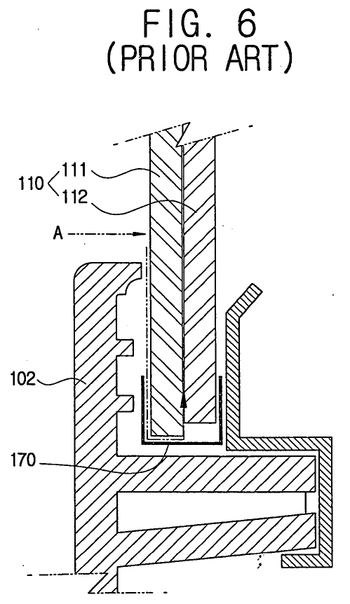

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

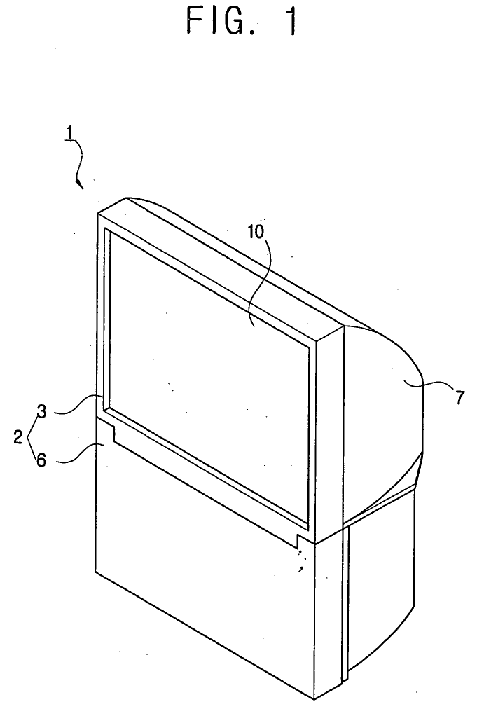

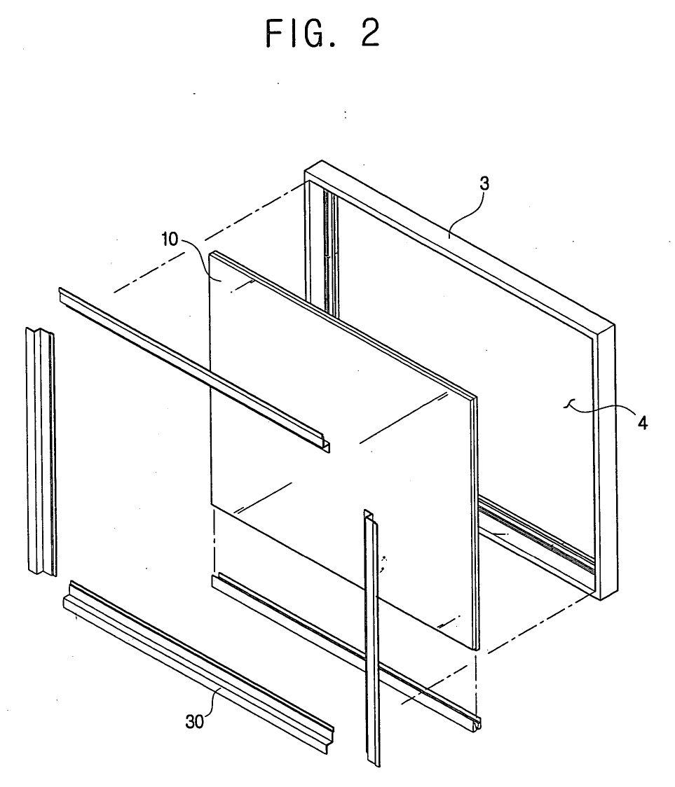

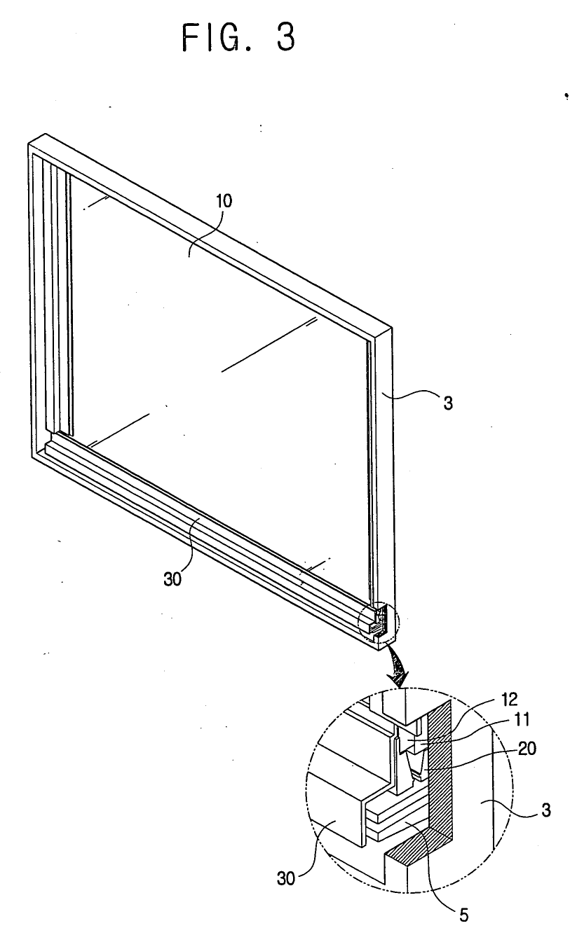

In FIGS. 1-4, a projection television according to an embodiment of the present invention comprises a body casing 1 forming an outer appearance having a front casing 2 and a rear casing 7, a CRT assembly (not shown) installed inside the body casing 1 and emitting an image beam, a reflecting mirror (not shown) reflecting the image beam emitted from the CRT assembly, a screen 10 provided on the front casing 2 and displaying a picture with the image beam reflected by the reflecting mirror.

The front casing 2 comprises an upper cover 3 having a front opening 4 through which the screen 10 can be exposed and combining with a front edge of the screen 10, and a lower cover 6 combining with a plurality of speakers (not shown) provided on a bottom of the upper cover 3.

The screen 10 comprises a lenticular lens sheet 11 in a front side of the screen and a fresnel lens sheet 12 in a rear side of the screen.

The lenticular lens sheet 11 is inscribed with vertical stripe patterns on a front and a back thereof, and the fresnel lens sheet 12 is inscribed with radial circle patterns, wherein a distance between the patterns on each sheet is approximately 0.1 mm.

The screen 10, comprising the lenticular lens sheet 111 assembled with the fresnel lens sheet 112, receives the image beam and displays the picture.

The screen 10 is supported by a supporting rib 5 of the upper cover 3, and a screen supporting bracket 30 combined to the supporting rib 5.

The supporting rib 5 is provided on an inside of the upper cover 3 and is formed along an edge of the front opening 4 of the upper cover 3 protruding inward. A supporting unit 20 is installed between a bottom of the screen 10 and the supporting rib 5 to support the bottom of the screen 10.

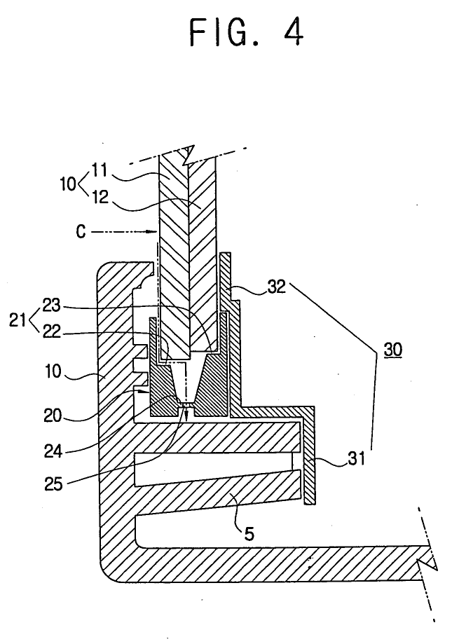

The supporting unit 20 supports the bottom of the screen 10 and discharges cleansing liquid or water that is sprayed along an arrow C in FIG. 4 and flows downward along the screen 10. Hereinbelow, the cleansing liquid or the water will be indicated as moisture.

A depression 24 is formed in a center of the supporting unit 20 and comprises sloped sides, wherein moisture drains downward along the sloped sides, and a drain hole 25 is formed at a bottom of the depression 24. An upper part of each of the sloped sides is formed with an insertion groove 21 and having a rectangular-shaped corner to allow a bottom edge of the screen 10 to be positioned in the rectangular-shaped corners when the screen 10 is slidingly inserted downward.

The insertion groove 21 comprises a pair of insertion grooves 22 and 23. The lenticular lens sheet 11 is inserted into a first insertion groove 22, and the fresnel lens sheet 12 is inserted into a second insertion groove 23. The first insertion groove 22 and the second insertion groove 23 are positioned at different heights, wherein the first insertion groove 22 is formed at a lower level than the second insertion groove 23 so that a lower end of the lenticular lens sheet 11 is positioned lower than a lower end of the fresnel lens sheet 12.

The depression 24 comprises the sloped sides so that the moisture permeated through a gap between the upper cover 3 and the lenticular lens sheet 11, accumulates on the first insertion groove 22 and drain downward along one of the sloped sides, wherein the insertion grooves 22 and 23 are formed on the upper parts of the sloped sides of the depression at different heights. The drain hole 25 is formed on the bottom of the depression 24 to discharge the moisture through the drain hole 25.

The screen supporting bracket 30 is made of a rigid material to support the rear of the screen 10 and is combined with the supporting rib 5. The screen supporting bracket 30 comprises a combining part 31 formed corresponding to the shape of the supporting rib 5 to combine the supporting rib 5 with the screen supporting bracket 30 and a contacting part 32 extending upward from the combining part 31 to support the screen 10 and contacting a rear of the screen 10 or the fresnel sheet 12.

Hereinbelow, in the projection television according to an embodiment of the present invention, the process for assembling the upper cover 3 and the screen 10 will be described.

The screen 10 is installed above the supporting rib 5 of the upper cover 3 so that the screen 10 is exposed to the outside through the front opening 4 of the upper cover 3, wherein the bottom of the screen 10 is inserted into the insertion groove 21 of the supporting unit 20. The lenticular lens sheet 11 of the screen 10 is inserted into the first insertion groove 22, and the fresnel lens sheet 12 of the screen 10 is inserted into the second insertion groove 23.

The screen supporting bracket 30 is combined with the supporting rib 5. When the combining part 31 of the screen supporting bracket 30 is combined with the supporting rib 5, the contacting part 32 of the screen supporting bracket 30 contacts the fresnel lens sheet 12 and supports the rear of the screen 10.

In the state described above, when a user sprays moisture such as cleansing liquid or water toward the screen 10 to remove dirt from the surface of the screen 10, the moisture permeates into the gap between the upper cover 3 and the lenticular lens sheet 11 of the screen 10 and flows downward along the surface of the lenticular lens sheet 11 and reaches the first insertion groove 22 of the supporting unit 20, then it is drained to the depression 24 and discharged to the outside through the drain hole 25.

As described above, in the projection television according to an embodiment of the present invention, the drain hole 25, formed on the supporting unit 20 supporting the bottom of the screen 10, prevents moisture from permeating through the gap between lenticular lens sheet 11 and the fresnel lens sheet 12 when the user cleans the screen 10 with the cleansing liquid, and therefore the drain hole 25 prevents the projection television from getting flecks on the screen 10.

The drain hole 25 prevents the moisture from permeating into the gap between the lenticular sheet 11 and the fresnel lens sheet 12 of the screen 10, and from deteriorating the screen 10.

As described above, the projection television according to an embodiment of the present invention, discharges the moisture permeated along the screen 10, thereby preventing the deterioration of the screen 10.

Although a few embodiments of the present invention have been shown and described, it will be appreciated by those skilled in the art that changes may be made in this embodiment without departing from the principles and spirit of the invention, the scope of which is defined in the claims and their equivalents.

What is claimed is:

1. A projection television comprising:
a screen displaying a picture;
a body casing forming an outer appearance of the projection television and combining with the screen;
a supporting unit provided on an inside of the body casing and supporting a bottom of the screen; and
a drain hole formed at a bottom of the supporting unit and discharging moisture permeated into the screen.

2. The projection television of claim 1, wherein the supporting unit comprises an insertion groove in which the bottom of the screen is inserted.

3. The projection television of claim 2, wherein the insertion groove comprises a first insertion groove and a second insertion groove, wherein the first insertion groove is formed at a lower level than the second insertion groove, to discharge the moisture through the drain hole.

4. The projection television of claim 3, wherein the supporting unit further comprises a depression formed in a center of the supporting unit and communicating with the first and second insertion grooves formed on upper parts of the depression, wherein the drain hole is formed at a bottom of the depression.

5. The projection television of claim 1, wherein the screen comprises:
a lenticular lens sheet on a front side of the screen; and
a fresnel lens sheet on a rear side of the screen, wherein the fresnal lens sheet is combined with the lenticular lens sheet.

6. The projection television of claim 2, wherein the screen comprises:
a lenticular lens sheet on a front side of the screen; and
a fresnel lens sheet on a rear side of the screen, wherein the fresnal lens sheet is combined with the lenticular lens sheet.

7. The projection television of claim 4, wherein the screen comprises:
a lenticular lens sheet on a front side of the screen; and
a fresnel lens sheet on a rear side of the screen, wherein the fresnal lens sheet is combined with the lenticular lens sheet.

8. The projection television of claim 7, wherein the body casing comprises:
a front casing comprising:
an upper cover having a front opening through which the screen is exposed and supporting the screen, and
a lower cover provided on a bottom of the upper cover; and
a rear casing combining with a rear of the front casing, wherein a supporting rib protrudes inward on an inside of the upper cover along an edge of the front opening of the upper cover and the supporting unit is provided between a bottom of the screen and the supporting rib.

9. The projection television of claim 8, further comprising a screen supporting bracket combined to the supporting rib to support a rear of the screen.

10. The projection television of claim 9, wherein the screen supporting bracket comprises:
a combining part formed corresponding to a shape of the support rib, to combine the supporting rib with the screen supporting bracket; and
a contacting part extending upward from the combining part, to support the screen and contacting the rear of the screen.

11. The projection television of claim 7, wherein the lenticular lens sheet is inserted into the first insertion groove and the fresnel lens sheet is inserted into the second insertion groove.

12. The projection television of claim 11, wherein a lower end of the lenticular lens sheet is positioned lower than a lower end of the fresnel lens sheet to discharge moisture accumulated on the lenticular lens through the drain hole.

13. The projection television of claim 4, wherein the depression comprises sloped sides wherein moisture accumulates on the first insertion groove and drains downward along one of the sloped sides and is discharged through the drain hole formed at the bottom of the depression.

14. The projection television of claim 13, wherein upper parts of the sloped sides are formed with the first and second insertion grooves, respectively at different heights, and each of the sloped sides have a rectangular-shaped corner to allow a bottom edge of the screen to be positioned in the rectangular-shaped corner when the screen is slidingly inserted downward into the supporting unit of the projection television.

15. The projection television of claim 9, wherein the screen supporting bracket is made of a rigid material to support the rear of the screen.

16. The projection television of claim 8, wherein moisture permeates into a gap between the upper cover and the lenticular lens sheet of the screen and flows downward along a surface of the lenticular lens sheet and reaches the first insertion groove of the supporting unit and is drained to the depression and discharged to an outside of the projection television through the drain hole.

17. The projection television of claim 16, wherein the drain hole prevents the moisture from permeating through a gap between the lenticular lens sheet and the fresnel lens sheet when a user cleans the screen with a cleansing liquid, thereby preventing the projection television from getting flecks on the screen.

18. The projection television of claim 17, wherein the drain hole prevents the moisture from permeating into the gap between the lenticular lens sheet and the fresnel lens sheet and from deteriorating the screen.
